(19) United States
(12) Patent Application Publication
(10) Pub. No.: US 2026/0249121 A1
(43) Pub. Date: Aug. 27, 2026

(54) FIRE SUPPRESSION SYSTEM

(71) Applicant: Tyco Fire Products LP, Cranston, RI (US)

(72) Inventor: Christopher James Downing, Shalford (GB)

(73) Assignee: Tyco Fire Products LP, Cranston, RI (US)

(21) Appl. No.: 19/163,555

(22) PCT Filed: May 28, 2024
(86) PCT No.: PCT/IB2024/055180

§ 371 Date: Sep. 9, 2025

Related U.S. Application Data
(60) Provisional application No. 63/504,817, filed on May 30, 2023.

(51) Int. Cl. A62C 35/02; A62C 3/16; A62C 35/10; A62C 35/64; A62C 35/68; A62C 99/00

(52) U.S. Cl. CPC A62C 35/023; A62C 3/16; A62C 35/10; A62C 35/645; A62C 35/68; A62C 99/0018

(57) ABSTRACT

An activation unit for a fire suppression system includes a body and a shuttle. The body defines an inner volume and is configured to couple with a fire suppression agent source at an inlet, an outlet conduit at an outlet, and further includes a pressure port. The shuttle is disposed within the inner volume. The shuttle is translatable between a first position and a second position. In the first position the outlet is sealed shut and in the second position, the outlet is fluidly coupled with the fire suppression agent source through the inlet and the inner volume. The shuttle is configured to transition out of the first position and into the second position responsive to a decrease in pressure at the pressure port. The pressure port is fluidly coupled with a chamber defined by the shuttle and the inner volume.

### CROSS-REFERENCE TO RELATED PATENT APPLICATION

This application claims the benefit of and priority to U.S. Provisional Application No. 63/504,817, filed May 30, 2023, the entire disclosure of which is incorporated by reference herein.

### BACKGROUND

Fire suppression systems are commonly used to protect an area and objects within the area from fire. Fire suppression systems can be activated manually or automatically in response to a fire condition such as an indication that a fire is present nearby (e.g., an increase in ambient temperature beyond a predetermined threshold value, etc.). Once activated, fire suppression systems spread a fire suppression agent throughout the area or confines of the protected object. The fire suppressant agent then suppresses or controls (e.g., reduces the intensity or prevents the growth of) the fire or can fully extinguish the fire.

### SUMMARY

One implementation of the present disclosure is a fire suppression system, according to some embodiments. In some embodiments, the fire suppression system can include a suppressant tank, an activation unit, and a release device. The suppressant tank can be configured to store a gaseous fire suppressant agent, according to some embodiments. The activation unit can be fluidly coupled at an inlet with the suppressant tank, according to some embodiments. The release device can be fluidly coupled with an outlet of the activation unit, according to some embodiments. In some embodiments, the release device can be configured to maintain a pressure on a low pressure side of the activation unit and release the pressure on the low pressure side in response to a thermal event or device operation at an asset that the fire suppression system serves. In some embodiments, the activation unit can be configured to transition from a deactivated state in which the gaseous fire suppressant agent can be limited from discharging through the activation unit, to an activated state in which the gaseous fire suppressant agent is discharged through the activation unit and the release device to provide fire suppression for the asset. In some embodiments, the activation unit is configured to transition from the deactivated state to the activated state in response to the pressure on the low pressure side of the activation unit being released.

In some embodiments, the activation unit includes at least one of a shuttle, a check valve, a flapper valve, or a burst disk. In some embodiments, the shuttle is positioned within a housing and is configured to move in response to release of the pressure on the low pressure side of the activation unit to transition the activation unit between the deactivated state and the activated state. In some embodiments, the check valve is configured to transition the activation unit from the deactivated state to the activated state in response to release of the pressure on the low pressure side of the activation unit. In some embodiments, the flapper valve is configured to transition the activation unit from the deactivated state to the activated state in response to release of the pressure on the low pressure side of the activation unit. In some embodiments, the burst disk is configured to transition the activation unit from the deactivated state to the activated state in response to release of the pressure on the low pressure side of the activation unit.

In some embodiments, the release device includes at least one of a thermally responsive tubular member or gas conduit, a soldered fitting or soldered hole, a channel, or a solenoid device. In some embodiments, the thermally responsive tubular member or gas conduit is configured to melt in response to the thermal event at the asset to release the pressure on the low pressure side of the activation unit. In some embodiments, the soldered fitting or soldered hole is disposed on a delivery device and is configured to melt in response to the thermal event at the asset to release the pressure on the low pressure side of the activation unit. In some embodiments, the channel is disposed in an enclosure of the asset configured to melt in response to the thermal event at the asset to release the pressure on the low pressure side of the activation unit. In some embodiments, the solenoid device is disposed in, or upstream of, an enclosure and is configured to be controlled and externally instructed to release the pressure on the low pressure side of the activation unit and allow flow through the solenoid device to the asset.

In some embodiments, the low pressure side of the activation unit is configured to be charged to maintain the pressure on the low pressure side if the release device has not released the pressure on the low pressure side. In some embodiments, the fire suppression system further includes at least one of a connection point, a pressurized reservoir, a compressor, or a bypass line. In some embodiments, the connection point is configured to receive a pump system provided by a technician to maintain the pressure on the low pressure side. In some embodiments, the pressurized reservoir is configured to fluidly couple with the low pressure side of the activation unit to maintain the pressure on the low pressure side. In some embodiments, the compressor is configured to fluidly couple with the low pressure side of the activation unit to maintain the pressure on the low pressure side. In some embodiments, cycling of the compressor is controlled by an automatic air maintenance controller. In some embodiments, the bypass line extends from a high pressure side of the activation unit proximate the inlet of the activation unit to the low pressure side of the activation unit to maintain the pressure on the low pressure side.

In some embodiments, the activation unit includes a shuttle positioned within a housing. In some embodiments, the shuttle is configured to move in response to release of the pressure on the low pressure side of the activation unit to transition the activation unit between the deactivated state and the activated state. In some embodiments, the release device includes a thermally responsive tubular member or gas conduit configured to melt in response to the thermal event at the asset to release the pressure on the low pressure side of the activation unit.

In some embodiments, the shuttle includes a first surface area and a second surface area. In some embodiments, the first surface area is greater than the second surface area and is configured to interface with a back-pressure from the release device. In some embodiments, the second surface area is configured to interface with a pressure from the suppressant tank. In some embodiments, a force exerted on the shuttle by the back-pressure from the release device on the first surface area is greater than or equal to a force exerted on the shuttle by the suppressant tank. In some embodiments, when the thermally responsive tubular member or the gas conduit is unruptured, the shuttle is maintained in a first position in which a flow path from the suppressant tank to the thermally responsive tubular member or the gas conduit is sealed such that the gaseous fire suppressant agent is limited from flowing past the shuttle to the thermally responsive tubular member or the gas conduit. In some embodiments, when the thermally responsive tubular member or the gas conduit is ruptured, the back-pressure on the shuttle is released and the shuttle is driven to move out of the first position and into a second position by the pressure from the suppressant tank. In some embodiments, when the shuttle is in the second position, the gaseous fire suppressant agent is allowed to flow through the shuttle to the thermally responsive tubular member or the gas conduit.

Another implementation of the present disclosure is a fire suppression system, according to some embodiments. In some embodiments, the fire suppression system includes at least one suppressant tank configured to store a gaseous fire suppressant agent, at least one tubular member, and an activation member. In some embodiments, the at least one tubular member is in fluid communication with the at least one suppressant tank and extends proximate a component or area that the fire suppression system serves. In some embodiments, the activation member includes a housing and a shuttle positioned within an inner volume of the housing. In some embodiments, the at least one tubular member includes a first section extending from the at least one suppressant tank to an inlet of the activation member, and a second section extending from an outlet of the activation member to proximate the component or area that the fire suppression system serves. In some embodiments, the shuttle is movable between a closed position in which the outlet of the activation member is covered by the shuttle such that the fire suppression system does not provide the gaseous fire suppressant agent to the component or area that the fire suppression system serves, and an open position in which a fluid flow path between the outlet of the activation member and the inlet is defined through the inner volume such that the fire suppression system provides the gaseous fire suppressant agent to the component or area that the fire suppression system serves. In some embodiments, the shuttle is movable between the closed position and the open position in response to a change in a pressure differential across the shuttle due to a fire event or thermal event occurring at the component or area that the fire suppression system serves.

In some embodiments, the shuttle includes a piston that seals with an inner cylindrical or conical surface of the activation member. In some embodiments, the activation member includes a filter and an orifice plate positioned along the fluid flow path. In some embodiments, the fluid flow path is defined between the inlet of the activation member and the outlet of the activation member. In some embodiments, the shuttle is configured to block the fluid flow path when in the closed position and allow the fluid flow path through the inner volume of the activation member when in the open position.

In some embodiments, the activation member includes an opening that extends through a wall in the activation member in a longitudinal direction. In some embodiments, the opening is fluidly coupled with a second tubular member that fluidly couples with the second section of the tubular members. In some embodiments, the second section of the tubular members include at least one thermally responsive tubular member or solenoid valve positioned proximate the area or component that the fire suppression system serves. In some embodiments, the at least one thermally responsive tubular member is configured to melt and break in response to the fire event or the thermal event. In some embodiments, the second tubular member and the second section of the tubular members form a sealed inner volume when the at least one thermally responsive tubular member are integral and have not melted and broken or the solenoid valve has operated. In some embodiments, the second tubular member and the second section of the tubular members provide a back-pressure to the inner volume of the activation member that biases the shuttle into the closed position and holds the shuttle in the closed position. In some embodiments, when the at least one thermally responsive tubular member melts and breaks, the back-pressure is released and the shuttle is driven by pressure of the gaseous fire suppressant agent at the inlet to move from the closed position to the open position such that the fluid flow path is defined between the inlet and the outlet of the activation member, and the gaseous fire suppressant agent is discharged through the second section of the tubular members and the at least one thermally responsive tubular member via a melt or burst point or solenoid operation to the component or the area that the fire suppression system serves.

In some embodiments, the gaseous fire suppressant agent exerts a pressure on a high pressure side of the shuttle that is greater than a pressure exerted on a low pressure side of the shuttle provided via the at least one tubular member. In some embodiments, the gaseous fire suppressant agent includes at least one inert gas.

In some embodiments, the outlet is fluidly coupled with a thermally responsive tubular member that is fluidly coupled with a pressure port on the housing of the activation member. In some embodiments, the outlet is configured to allow re-pressurization of the thermally responsive tubular member to re-seat the shuttle into the closed position responsive to a leak in the thermally responsive tubular member that causes the shuttle to transition out of the closed position.

Another implementation of the present disclosure is an activation unit for a fire suppression system, according to some embodiments. In some embodiments, the activation unit includes a body and a shuttle. In some embodiments, the body defines an inner volume. In some embodiments, the body is configured to couple with a fire suppression agent source at an inlet, an outlet conduit at an outlet, and further includes a pressure port. In some embodiments, the shuttle is disposed within the inner volume. In some embodiments, the shuttle is translatable between a first position and a second position. In some embodiments, in the first position the outlet is sealed shut and in the second position, the outlet is fluidly coupled with the fire suppression agent source through the inlet and the inner volume. In some embodiments, the shuttle is configured to transition out of the first position and into the second position responsive to a decrease in pressure at the pressure port. In some embodiments, the pressure port is fluidly coupled with a chamber defined by the shuttle and the inner volume.

In some embodiments, the pressure port and the outlet are both fluidly coupled with a thermally responsive tubular member. In some embodiments, rupturing of the thermally responsive tubular member causes the pressure at the pressure port to decrease such that a force exerted on an opposite side of the shuttle drives the shuttle to transition out of the first position and into the second position.

In some embodiments, the shuttle includes a first portion and a second portion. In some embodiments, the first portion has a first diameter and the second portion has a second diameter. In some embodiments, the first diameter is greater than the second diameter.

In some embodiments, the activation unit includes a passageway that fluidly couples the inlet with the fire suppression agent source. In some embodiments, an orifice plate is disposed along the passageway.

In some embodiments, the shuttle defines a first chamber and a second chamber within the inner volume. In some embodiments, the first chamber has a first pressure and the second chamber has a second pressure lower than the first pressure. In some embodiments, the second chamber fluidly couples with the pressure port and the first chamber fluidly couples with the inlet. In some embodiments, the shuttle includes a first surface area on which the first pressure acts, and a second surface area on which the second pressure acts. In some embodiments, the first surface area is smaller than the second surface area.

In some embodiments, the activation unit includes a passageway that fluidly couples the inlet with the fire suppression agent source. In some embodiments, an orifice restrictor plate and a filter are disposed along the passageway.

### BRIEF DESCRIPTION OF THE DRAWINGS

The disclosure will become more fully understood from the following detailed description, taken in conjunction with the accompanying FIGURES, wherein like reference numerals refer to like elements, in which:

FIG. 1 is a diagram illustrating a wind turbine including a fire suppression system, according to some embodiments.

FIG. 2 is a perspective view of a portion of the wind turbine and the fire suppression system of FIG. 1, according to some embodiments.

FIG. 3 is a diagram illustrating a thermally responsive conduit or polymeric tube that carries a fire suppression agent when a fire event occurs proximate the thermally responsive conduit, according to some embodiments.

FIG. 4 is a diagram illustrating the thermally responsive conduit having burst to thereby provide a localized application of fire suppression agent to the fire event, according to some embodiments.

FIG. 5 is a diagram of the fire suppression system of FIG. 1, according to some embodiments.

FIG. 6 is a sectional view of an activation unit of the fire suppression system of FIG. 5, according to some embodiments.

FIG. 7 is another sectional view of the activation unit of the fire suppression system of FIG. 5 in a closed position, according to some embodiments.

FIG. 8 is a sectional view of the activation unit of the fire suppression system of FIG. 7 in an open position, according to some embodiments.

FIG. 9 is a diagram illustrating a low pressure side of the activation unit of FIG. 5, according to some embodiments.

FIG. 10 is a diagram illustrating multiple suppressant tanks for the fire suppression system of FIG. 1, according to some embodiments.

FIG. 11 is a block diagram of a control or notification system of the fire suppression system of FIG. 1, according to some embodiments.

FIG. 12 is a block diagram of a fire suppression system, according to some embodiments.

FIG. 13 is a sectional view of the activation unit of the fire suppression system of FIG. 5, according to some embodiments.

FIG. 14 is a sectional view of the activation unit of the fire suppression system of FIG. 13 in a close position, according to some embodiments.

FIG. 15 is a sectional view of the activation unit of the fire suppression system of FIG. 13 in a partially open position, according to some embodiments.

FIG. 16 is a sectional view of the activation unit of the fire suppression system of FIG. 13 in an open position, according to some embodiments.

FIG. 17 is a sectional view of the activation unit of the fire suppression system of FIG. 13 in the open position with pressure exerted to transition the activation unit into the closed position, according to some embodiments.

### DETAILED DESCRIPTION

Before turning to the FIGURES, which illustrate the exemplary embodiments in detail, it should be understood that the present disclosure is not limited to the details or methodology set forth in the description or illustrated in the FIGURES. It should also be understood that the terminology used herein is for the purpose of description only and should not be regarded as limiting.

### Overview

Referring generally to the FIGURES, a fire suppression system may provide fire suppression for one or more assets or components of a system (e.g., a wind turbine). The fire suppression system may include one or more suppressant tanks that store inert gas or a suppressant agent in a gaseous phase and are fluidly coupled with an activation unit through one or more conduits, tubular members (e.g., hoses, pipe, piping, pipework), etc. The activation unit may include a piston that is repositionable within a chamber of the activation unit between a closed position and an open position. The activation unit may include a first outlet and a second outlet. The first outlet and the second outlet are both fluidly coupled with one or more conduits or tubular members that are fed to one or more assets of the system to be protected (e.g., a generator of the wind turbine). The conduits or tubular members may include thermally responsive tubular members that are configured to melt and therefore rupture and define a discharge orifice for the suppressant agent or inert gas to discharge or be a fixed device (e.g., a sprinkler head with temperature operated seal) which liberates suppressant agent (e.g., extinguishant) upon heat activation. The thermally responsive members can therefore function both to activate a fire suppression system and to discharge suppressant agent or inert gas to one or more assets of the system. The thermally responsive members may fluidly couple with both the first outlet and the second outlet of the activation unit such that, before the thermally responsive members have melted, burst, or operated, a back pressure can be formed within the chamber to push the piston (e.g., a shuttle) into the closed position where the second outlet can be blocked.

The first outlet may be formed in an end of the activation unit in a direction that can be the same as a direction of motion of the piston. The second outlet of the activation unit may be formed in a sidewall of the activation unit in a direction that can be perpendicular with the direction of motion of the piston. The piston can include a larger portion upon which the back pressure from the thermally responsive tubular members act such that a force results that holds the piston in the closed position. The suppressant tanks may be fluidly coupled with an inlet of the activation unit and can provide a higher pressure than the back pressure on a smaller surface area of the piston, such that a smaller force results on the piston to push the piston into the open position. Since the force produced by the back pressure can be greater than the force produced by the pressurized inert gas or suppressant agent, the piston can be held in the closed position until the thermally responsive tubular members rupture or a device operates (e.g., a solenoid serving a specific protected asset) and thereby relieve the back pressure. When the back pressure can be relieved, the piston translates to the open position and a flow path can be formed between the suppressant tanks and the ruptured portion of the thermally responsive tubular members through the inlet and the second outlet of the activation unit. The system could also be so configured, similar to a pre-action sprinkler, where the pressure within the storage vessel (inert gas cylinder(s)) can be contained and held closed by their own cylinder valve, and that can be only operated on instruction from a fire detection system, e.g., by solenoid actuation on the storage vessel valve, thereby presenting pressure to inlet.

Advantageously, the system may be activated without requiring electronic sensors. The activation unit may include a low pressure side therewithin. The low pressure side may correspond to the back pressure. Once the back pressure is relieved (e.g., the low pressure is relieved) due to melting or release of pressure by mechanical means (e.g., melting of a thermally responsive tubular member), the activation unit allows the flow of fire suppression agent to assets of the wind turbine. Wind turbines may be difficult to access and typically have high elevation. Accordingly, the system can be operated without requiring sensors and can provide pressure regulation to provide fire suppression agent to the wind turbine nacelle while allowing storage of tanks on the ground, thereby overcoming various distance and height limitations. When the activation unit is activated due to the relieving of the low pressure side (e.g., the back pressure), the shuttle may transition, allowing the flow of highly pressurized fire suppression agent through the activation unit. Accordingly, the activation units can advantageously interact with both high pressure (on the inlet through which fire suppression agent is provided) and use low pressure (on the low pressure side) for activation.

### Wind Turbine

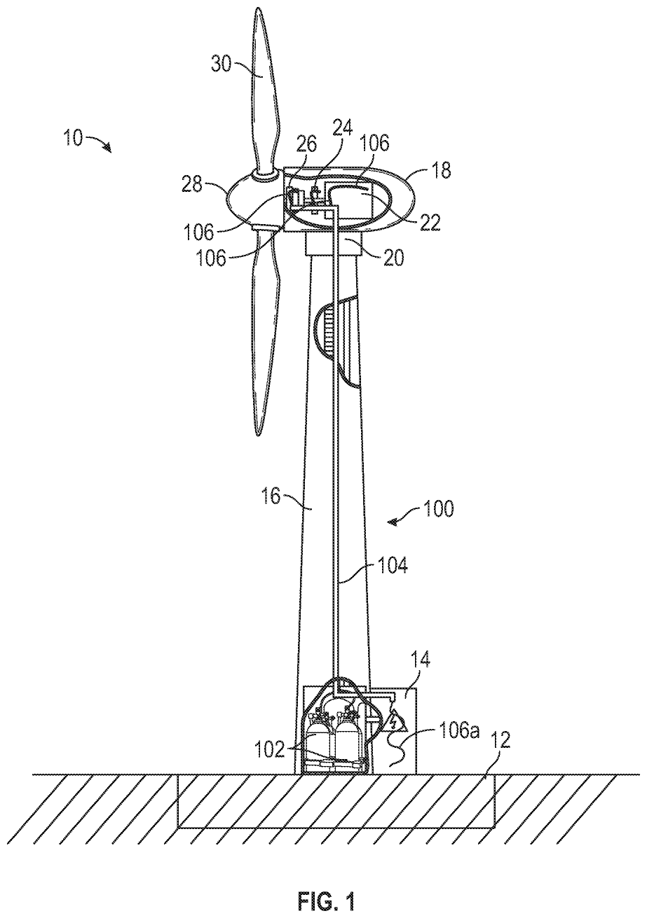

Referring particularly to FIGS. 1-4, a wind turbine 10 can include a base portion 16 (e.g., a structural member, a tower, etc.) that can be secured (e.g., coupled, cemented, anchored, etc.) onto a ground surface 12 (e.g., a foundation) or sea structure of offshore wind turbines. The wind turbine 10 also can include a nacelle 18 that can be positioned on an upper end of the base portion 16. The base portion 16 extends upwards into the air from the ground surface 12 such that turbine blades 30 are positioned at an elevated position in order to catch cross-winds and be driven to rotate. The nacelle 18 can be coupled with the base portion 16 through a rotatable coupler 20 that can adjust an orientation of the nacelle 18 and the turbine blades 30 (e.g., a yaw) so that the nacelle 18 and the turbine blades 30 catch a cross-wind. In some embodiments, each of the turbine blades 30 couple with a rotor hub 28 at a front of the nacelle 18 and include individual pitch control. In some embodiments, the wind turbine 10 can include a rotor 34 which can be configured to be driven to rotate due to wind speeds.

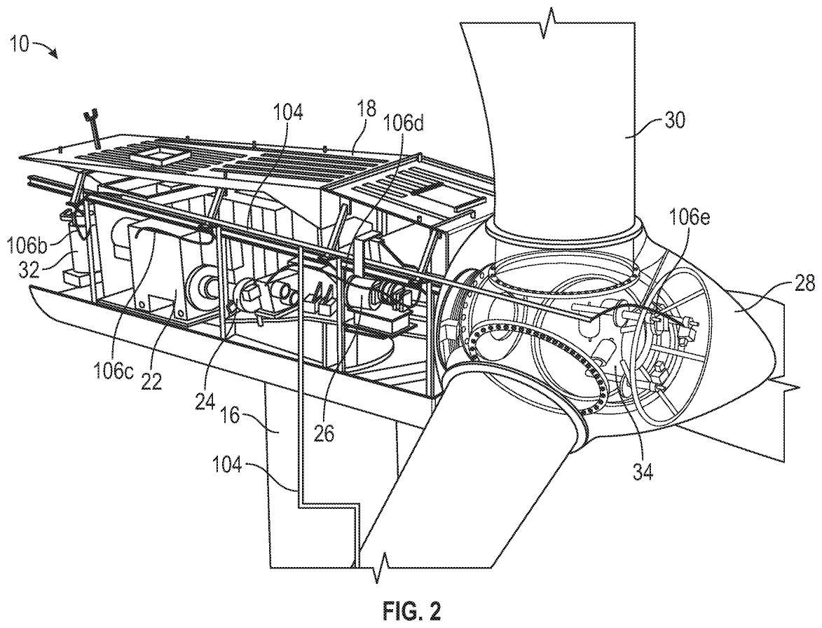

Referring to FIGS. 1-2, the wind turbine 10 can include a gearbox 26 positioned within the nacelle 18. The gearbox 26 can be configured to be driven to rotate by the turbine blades 30 as the turbine blades 30 rotate. The wind turbine 10 also can include an electric or mechanical brake, shown as brake 24 that can be configured to be driven by the turbine blades 30 through the gearbox 26. The brake 24 may be transitionable between an engaged state or position in which rotation of the turbine blades 30 can be limited, and a disengaged state or position in which rotation of the turbine blades 30 can be allowed. The wind turbine 10 also can include a generator 22 and a transformer 32. The generator 22 can be driven to rotate by the turbine blades 30 through the gearbox 26 and the brake 24, and generates electrical energy by converting mechanical energy to electrical energy. In some embodiments, the electrical energy that can be generated by the generator 22 can be provided to the transformer 32, which can be electrically coupled via cables that extend through the base portion 16 at a grid connection 14 in a base or bottom of the base portion 16. Other arrangements may prevail but are similar in objective (e.g., transforming kinetic wind energy into electrical energy for transport to transformation, distribution and use).

Referring particularly to FIGS. 1-2, the wind turbine 10 can be provided with a fire suppression system 100 that can be configured to activate and provide fire suppression in response to detection of a condition (e.g., a temperature increase, heat transfer or heat increase, a fire event, a combustion, an indication of thermal runaway, etc.) at any electrical components of the wind turbine 10 (e.g., within the nacelle 18, at the grid connection 14, etc.) within which the conduit can be installed. In some embodiments, the fire suppression system 100 can be configured to provide a discharge of an inert gas or suppressant agent to one or more electrical components or target components of the wind turbine 10 in response to the condition occurring at the electrical components or target components. In some embodiments, the fire suppression system 100 provides localized and targeted application of the inert gas or the suppressant agent in response to the condition occurring in order to suppress the condition, extinguish a fire, interrupt thermal runaway, provide cooling, deprive a fire of oxygen, etc. In some embodiments, the suppression of the fire can be achieved by the suppressant agent or inert gas to provide cooling which results due to thermodynamics. If the condition occurs at the generator 22 of the nacelle 18 but not at the grid connection 14, the fire suppression system 100 can provide discharge of the inert gas or the suppressant agent to the generator 22 but not to the grid connection 14. Advantageously, providing localized and targeted application of the inert gas or the suppressant agent facilitates improved efficiency of an available amount of the inert gas or the suppressant agent over an extended discharge time period. In some embodiments, the inert gas or the suppressant agent may be any of an IG-100 pure nitrogen gas, an IG-01 pure argon gas, an IG-55 blend of argon and nitrogen gas, or an IG-541 blend of nitrogen, argon, and CO2 gases. Other blends or inert gases could be used but the aforementioned may be the principal agents that are internationally recognized in such systems (e.g., ISO 14520, EN 15004).

Referring still to FIGS. 1-2, the fire suppression system 100 can include multiple containers, tanks, reservoirs, capsules, etc., shown as suppressant tanks 102. The suppressant tank or tanks 102 are configured to store the inert gas or the suppressant agent and discharge the inert gas or the suppressant agent through a distribution system of pipes, conduits, tubular members, etc., in response to the condition occurring at a component of the wind turbine 10. The fire suppression system 100 can include one or multiple tubular members 104 (e.g., conduits, lines, pipes, hoses, etc.) that fluidly couple with the suppressant tanks 102 and are directed to one or more of the components of the wind turbine 10. In some embodiments, the tubular members 104 define a network of tubes that extend above or to the one or more components of the wind turbine 10 for which fire suppression can be desired (e.g., the components of the nacelle 18 such as the generator 22, the brake 24, the gearbox 26, and the transformer 32, and the grid connection 14). In some embodiments, the tubular members 104 are larger in order to achieve a desired discharge flow rate or address back pressure in the tubular members 104 and/or rigid members (e.g., hard pipes).

Referring still to FIGS. 1-2, the fire suppression system 100 also can include one or multiple thermally responsive tubular members 106 (e.g., polymer tubes, a polymeric material, direct low pressure tubes, or thermally operated devices such as a sprinkler type head, etc.) that are fluidly coupled with the tubular members 104. The thermally responsive tubular members 106 are positioned or installed within a bounding enclosure of each of the one or more components or assets of the wind turbine 10 for which fire suppression can be provided. For example, each of the components of the wind turbine 10 include a corresponding thermally responsive tubular member 106 positioned within the component such that if the condition occurs in the component, the thermally responsive tubular members 106 are positioned to provide a delivery or discharge of the inert gas or the fire suppression agent to the component. For example, a first thermally responsive tubular member 106a can be positioned within the grid connection 14, a second thermally responsive tubular member 106b can be positioned within an enclosure of the transformer 32, a third thermally responsive tubular member 106c can be positioned within an enclosure of the generator 22, a fourth thermally responsive tubular member 106d can be positioned within an enclosure of the brake 24 and the gearbox 26, and a fifth thermally responsive tubular member 106e can be positioned within an enclosure of the rotor 34. In some embodiments, all of the thermally responsive tubular members 106 are fluidly coupled with the tubular member 104 and thereby fluidly coupled with the suppressant tank or tanks 102. The thermally responsive tubular members 106 may be installed within each asset but are shown superimposed for illustrative purposes.

In some embodiments, the thermally responsive tubular members 106 may be replaced with or used in addition with a different actuation means. For example, the thermally responsive tubular members 106 may be replaced with one or more hard piped tubular members that do not melt or burst in response to temperature, and may be fluidly coupled with one or more valves having thermally responsive members (e.g., a bulb, a fusible plug or alloy head, a soldered head, a sealed section with structure to open responsive to a temperature or fire event, etc.) that cause actuation of the valves (e.g., sprinklers, sprinkler heads, discharge devices, nozzles, sprayers, etc.) from a closed position to an open position.

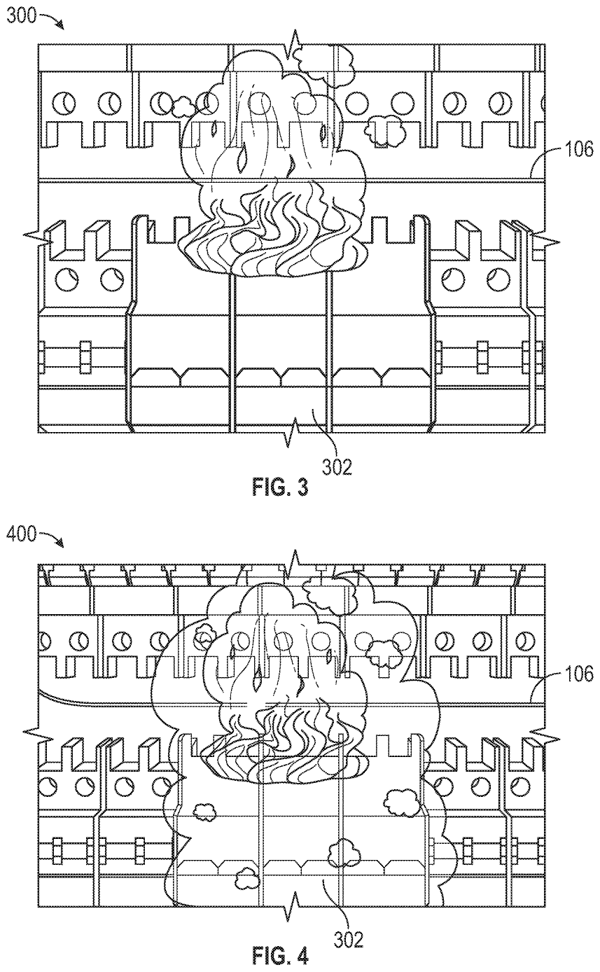

Referring particularly to FIGS. 3-4, a diagram 300 and a diagram 400 illustrate operations of the thermally responsive tubular member 106 for an asset 302 when a fire event occurs at the asset 302. The asset 302 may represent a computer device, a battery device, an electrical device, or any components of the wind turbine 10 such as the grid connection 14, the transformer 32, the generator 22, the brake 24, the gearbox 26, and/or the rotor 34. When a thermal condition (e.g., a fire event, a conflagration event, thermal runaway, excessive heat transfer, etc.) occurs at the asset 302, the thermally responsive tubular member 106 may melt and burst, thereby releasing inert gas that can be within the thermally responsive tubular member 106 onto, toward, or around the asset 302 to extinguish or suppress the fire event at the asset 302. In some embodiments, rupture of the thermally responsive tubular members 106 results in an open flow path being formed between the suppressant tank or tanks 102 and the asset 302 such that the suppressant agent can be discharged from the suppressant tank or tanks 102 onto the asset 302. In some embodiments, the discharge of the suppressant agent provides suppression by both providing the inert gas or the suppressant agent to thereby deprive any fires on the asset 302 from consuming oxygen, and also by blowing or discharging the suppressant agent onto the asset 302 at a rate such that the fire at the asset 302 can be extinguished or blown out.

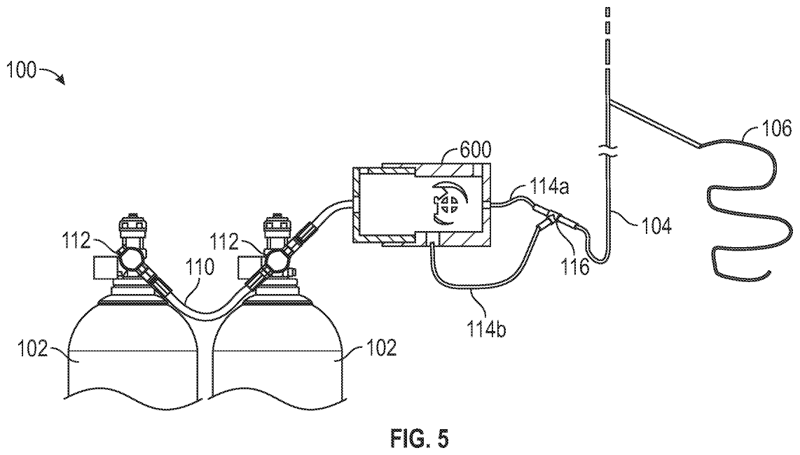

Referring to FIG. 5, the fire suppression system 100 can include the suppressant tank or tanks 102, a activation unit 600 (e.g., an activation member, a housing, an intermediate member, a manifold, etc.), tubular members 114, a connector 116, the tubular members 104, and the thermally responsive tubular members 106. In some embodiments, the suppressant tank or tanks 102 each include a valve 112 that are fluidly coupled with each other through an intermediate tubular member 110, or hard pipe manifold, and fluidly coupled with an inlet of the activation unit 600. When the thermally responsive tubular member 106 ruptures or breaks, the activation unit 600 may transition from a closed position to an open position to allow flow of the suppressant agent out of an outlet of the activation unit 600 through the tubular member 114b, the tubular member 104, and the thermally responsive tubular member 106.

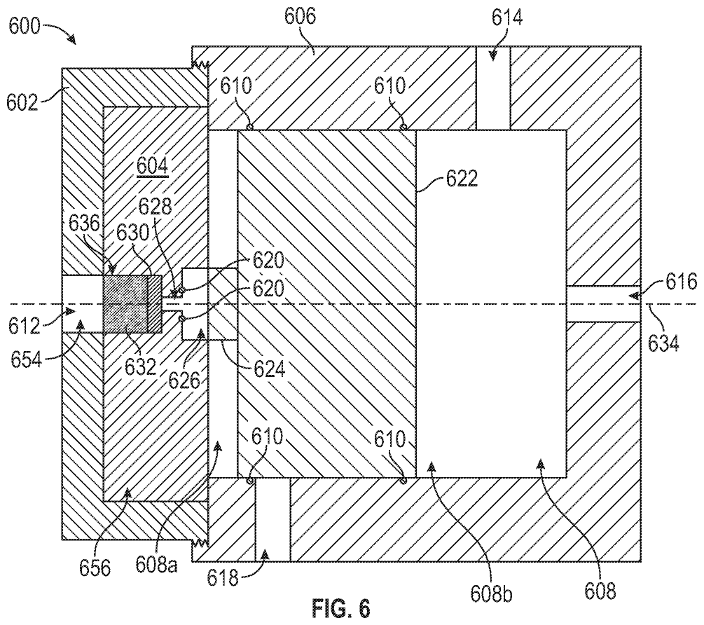

Referring particularly to FIG. 6, the activation unit 600 can be shown in greater detail, according to some embodiments. The activation unit 600 can be configured to transition between a first position or configuration (e.g., a closed position) and a second position or configuration (e.g., an open position). In some embodiments, the activation unit 600 can be in the closed position (e.g., the first position or configuration) until one or more of the thermally responsive tubular members 106 melt, which thereby causes the activation unit 600 to transition into the open position (e.g., the second position or configuration). In some embodiments, the activation unit 600 can include a first body member 602, a second body member 604, and a third body member 606. In some embodiments, the first member 602 defines an inlet 612 that can be fluidly coupled with the suppressant tank or tanks 102. The second body member 604 can be received within a void of the first body member 602 downstream of the inlet 612. In particular, the first body member 602 may include the inlet 612 and a first passage 654 at the inlet 612 that fluidly couples with a second passage or inner volume 656 that has a larger diameter than the first passage. The second passage or inner volume 656 and the first passage 654 may define a shoulder or a step at a transition between the first passage and the second passage. The second body member 604 may have a length or thickness that can be substantially equal to the length of the second passage or inner volume 656 along a longitudinal axis 634 of the activation unit 600.

In some embodiments, the first body member 602 can be coupled with or received within the third body member 606 and retains the second body member 604 between the first body member 602 and the third body member 606. The first body member 602 may press the second body member 604 into engagement with a corresponding surface of the third body member 606. In some embodiments, the third body member 606 can include a step or shoulder (e.g., a recess) in an end that receives the first body member 602. In some embodiments, the first member 602 threads into the third member 606. In other embodiments, the first member 602, the second member 604, and the third member 606 are integrally formed or otherwise coupled with each other (e.g., fastened, welded, adhered, interlocked, compression fit, friction fit, etc.).

The first body member 602, the second body member 604, and the third body member 606 cooperatively define an inner volume 608 within which a translatable or movable member, shown as shuttle 622 and 624 (e.g., a damper, a piston, etc.) can be positioned. In some embodiments, the second member 604 can include a passageway having a first portion 636 and a first diameter, a second portion 628 and a second diameter, and a third portion 626 and a third diameter. The first portion 636, the second portion 628, and the third portion 626 define a flow path through the second body member 604. The second diameter may be smaller than the first diameter and the third diameter. In some embodiments, the first portion 636 and the second portion 628 define a step or shoulder and an engagement surface at a transition between the first portion 636 and the second portion 628. The second body member 604 may include a filter 632 positioned within the first portion 636 and an orifice plate 630 (e.g., an orifice plate restrictor, an orifice restrictor, etc.) positioned between the engagement surface and the filter 632. The orifice plate 630 may engage the engagement surface at the transition between the first portion 636 and the second portion 628. The third portion 626 may have the third diameter that can be larger than the first diameter of the first portion 636. The orifice plate 630 has an opening or orifice positioned centrally and directly upstream of the second portion 628. The orifice of the orifice plate 630 can be sized such that a flow rate of the inert gas or fire suppressant agent through the activation unit 600 can be controlled at a desired rate. The filter 632 may reduce a likelihood that the orifice of the orifice plate 630 becomes blocked. The inlet 612 may have a diameter or radius that is smaller than a corresponding diameter or radius of the filter 632 to facilitate retention of the filter 632.

Referring still to FIG. 6, the shuttle 622 may include a protrusion, a tab, a stopper, etc., which may be cylindrical, conical, etc., shown as stopping member 624. The stopping member 624 extends from a side of the shuttle 622 that faces the second body member 604.

The stopping member 624 can be positioned centrally on the shuttle 622 and can be sized such that the stopping member 624 can be received within the third portion 626 when the shuttle 622 can be in engagement with the second body member 604. The second body member 604 can include a seal 620 that can be disposed on a surface of the third portion 626 proximate the transition between the third portion 626 and the second portion 628. When the shuttle 622 can be in engagement with the second body member 604 (e.g., in a closed position, the closed position of the activation unit 600), the seal 620 engages the stopping member 624 such that a seal can be formed and the fire suppressant agent can be limited from flowing out of the activation unit 600. The shuttle 622 also can include multiple seals 610 positioned on an outer surface of the shuttle 622. The seals 610 are configured to engage a corresponding inner surface of the third body member 606 such that the fire suppressant agent can be limited from flowing around the shuttle 622 as the shuttle 622 translates or moves along the inner volume 608. When the shuttle 622 can be in the closed position, the shuttle 622 blocks the third outlet 618 and limits the flow of the fire suppressant agent through the activation unit 600 (e.g., prevents discharge of the fire suppressant agent from the suppressant tank or tanks 102).

The third body member 606 can include a first outlet 614, a second outlet 616, and a third outlet 618. The first outlet 614 and the third outlet 618 may be positioned on opposite sides of the third body member 606 and extend in a direction that is perpendicular with the longitudinal axis 634. In some embodiments, the second outlet 616 can be positioned on an end of the third body member 606 opposite the end at which the first body member 602 couples with the third body member 606. The second outlet 616 may be positioned centrally and extends in a parallel direction with or along the longitudinal axis 634. In some embodiments, a first of the tubular members 114, shown as first tubular member 114a can be fluidly coupled with the second outlet 616. In some embodiments, the second outlet 616 can be a pneumatic actuation outlet. When the thermally responsive tubular members 106 melt, the second outlet 616 can be vented through the aperture of the melt point to atmospheric pressure, and the back pressure that can be exerted to maintain the shuttle 622 on the second body member 604 ceases or decreases (e.g., due to the drop in pressure). When the pressure that can be exerted on the shuttle 622 decreases (e.g., towards atmospheric pressure), the shuttle 622 can be driven to translate out of engagement with the second body member 604 by pressure exerted on the stopping member 624 by the fire suppressant agent (e.g., through the inlet 612). The shuttle 622 may translate to the end of the third body member 606 at which the second outlet 616 can be located, and thereby allow the flow of fire suppression agent through the inlet 612, the filter 632, the orifice of the orifice plate 630, the second portion 628, the third portion 626, the inner volume 608a, and out of the inner volume 608a through the third outlet 618. The shuttle 622 may divide the inner volume 608 into a first inner volume 608a (e.g., a flow side of the shuttle 622 proximate the inlet 612) and a second inner volume 608b (e.g., a closing side of the shuttle 622 proximate the second outlet 616).

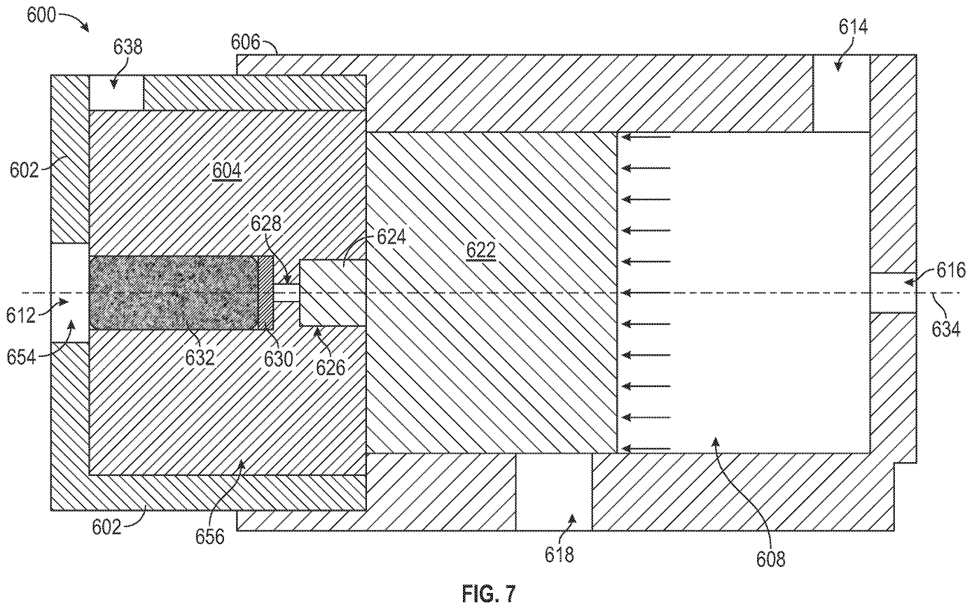

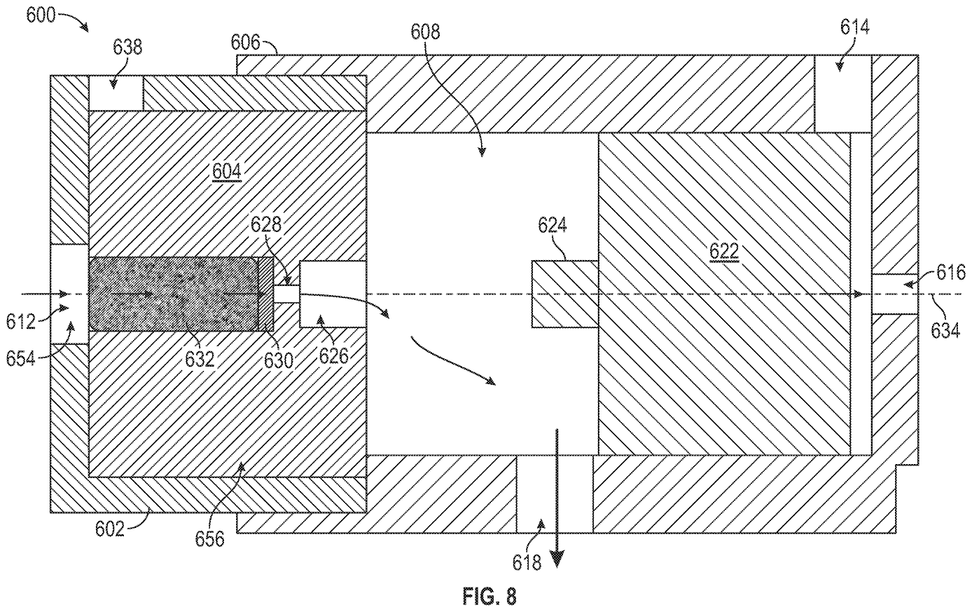

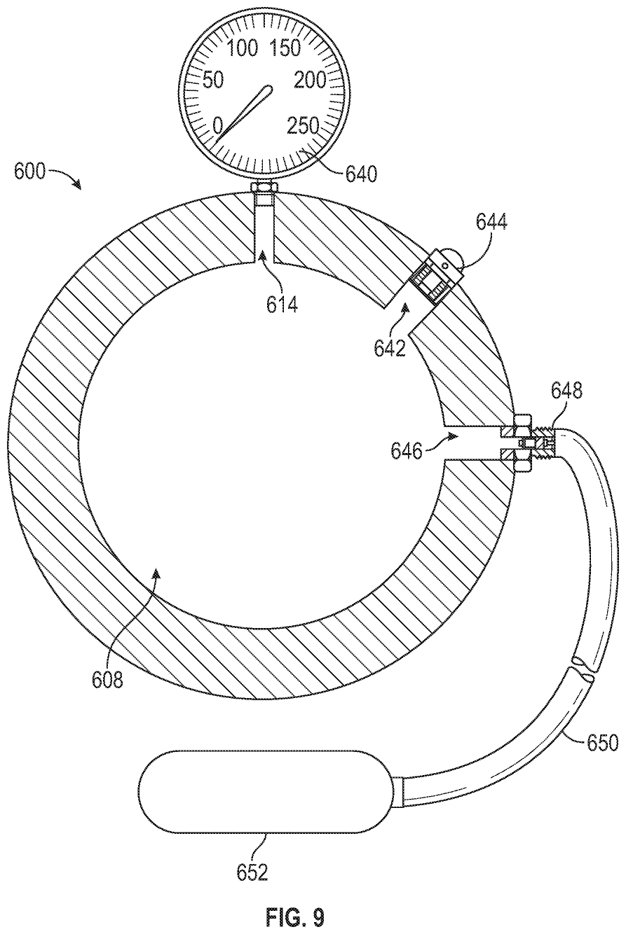

Referring to FIGS. 7 and 8, the shuttle 622 can be shown in the closed or first position and the open or second position, respectively. In particular, FIG. 7 illustrates the shuttle 622 translated into engagement with the second body member 604 such that the shuttle 622 blocks flow of the inert gas or the fire suppressant agent into the inner volume 608 of the third body member 606 through the inlet 612. When the shuttle 622 can be in the first position as shown in FIG. 7, the stopping member 624 can be received within the third portion 626 of the second body member 604 such that the third portion 626 can be plugged and the fire suppressant agent from the suppressant tank or tanks 102 can be limited from flowing through the activation unit 600 to the outlet 618. The shuttle 622 may be held in engagement with the second body member 604 due to pressure held in the inner volume 608 when the thermally responsive tubular members 106, which are fluidly coupled with the second outlet 616, are integral and have not yet burst. Once the thermally responsive tubular members 106 experience a specific temperature or amount of heat transfer, the thermally responsive tubular members 106 may melt, burst, or otherwise break open, thereby relieving the pressure that can be within the inner volume 608. The shuttle 622 may be driven, by the pressure exerted by the inert gas or the fire suppressant agent within the inlet 612 to translate to the second position as shown in FIG. 8.

When the shuttle 622 translates into the second or open position as shown in FIG. 8, a flow path can be defined between the inlet 612 and the third outlet 618 (e.g., the discharge outlet 618) such that the inert gas or the fire suppressant agent flows from the suppressant tank or tanks 102, through the inlet 612, the filter 632 if present, the orifice plate 630, the second portion 628, the third portion 626, the inner volume 608, and exits the inner volume 608 through the third outlet 618 (e.g., to the thermally responsive tubular members 106) and can be discharged onto an asset or locations where the thermal event has occurred and the thermally responsive tubular members 106 have burst or broken open. In some embodiments, the shuttle 622 can be held in the closed position as shown in FIG. 7 because the differential or back pressure held by the first tubular member 114a and the second tubular member 114 b, while low (e.g., 5 to 15 bar), acts on a high surface area of the shuttle 622, thereby producing a higher force on the shuttle 622 than the force produced by the higher pressure inert gas of the suppressant tank or tanks 102 (e.g., 60 bar) which acts on a smaller surface area of the shuttle 622, thereby producing a lower force.

Referring particularly to FIG. 7, the activation unit 600 may include the first outlet 614 (e.g., a low pressure port) and/or a high pressure port 638. The high pressure port 638 may provide a location to measure a high pressure side of the pressure differential across the shuttle 622. The low pressure port, or the first outlet 614 provides a location to measure a low pressure side of the pressure differential across the shuttle 622. In some embodiments, pressure gauges are installed at either or both the high pressure port 638 and the first outlet 614 to respectively measure the high pressure side and the low pressure side of the shuttle 622 to verify system health such as at service inspections such as to ensure that there are no leaks in the fire suppression system 100 on either side of the shuttle 622.

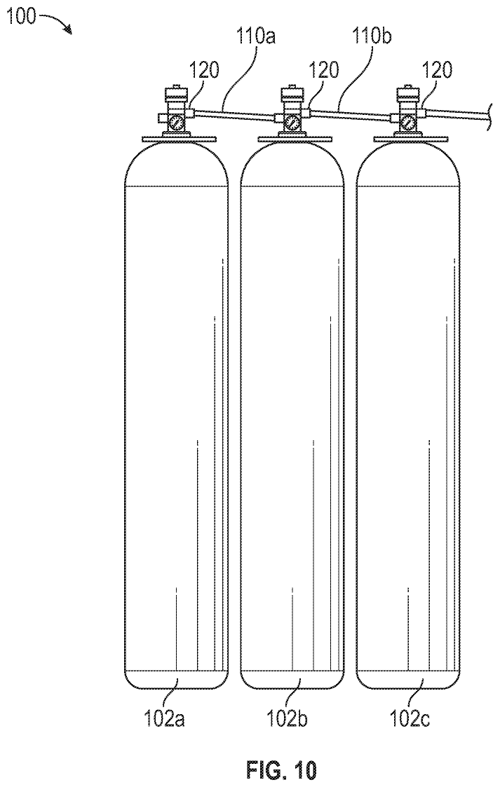

Referring to FIG. 10, the fire suppression system 100 may include one or multiple of the suppressant tanks 102 (e.g., suppressant tank 102a, suppressant tank 102b, suppressant tank 102c, etc.), depending on a desired flow duration or effective “hold” time. For example, the fire suppression system 100 may discharge fire suppressant agent or inert gas to one or more assets to initially suppress a fire or thermal event, and may continue to discharge the suppressant agent or the inert gas over a time period (e.g., the “hold” time) following the initial detection of the fire or thermal event in order to maintain oxygen levels at a sufficiently low level within the asset (e.g., any electrical components of the wind turbine 10) to reduce a likelihood of reignition or spread of the fire or thermal event. In some embodiments, the hold time may be increased or set to a desired time by increasing a number of suppressant tanks 102 of the fire suppression system 100 (e.g., by installing additional suppressant tanks 102 in series and connecting them through tubular members 110a, 110b, etc.), volume of the suppressant tanks 102 or stored pressure within the suppressant tanks 102. The hold time may be increased based on an estimated response time of a technician or response crew from a time at which the fire event or thermal event can be first detected, or as stakeholders deem to have secured extinguishing and prevent the likelihood of reignition. In some embodiments, the hold time can be increased such that suppression can be maintained at the asset until the response crew arrives. For example, wind turbines 10 may be in a remote location so that response may take a longer time (e.g., an hour, several hours). The hold time of the suppression system 100 can easily be increased by adding additional suppressant tanks 102 such that oxygen levels at the asset are held at a sufficiently low level until the response crew arrives or where impracticable that appreciable cooling will have occurred through time extinguished and flow thermodynamics and the persistent ignition source (e.g., power) addressed. In some embodiments, each of the suppressant tanks 102 can include a corresponding flow restricting orifice 120 such that the discharge rate of the suppressant tanks 102 can be reduced or limited in order to achieve an extended hold time. In some embodiments, each of the suppressant tanks 102 has a predetermined capacity such as 140 liters or 80 liters. In some embodiments, each of the suppressant tanks 102 include a regulator configured to control a discharge rate of suppressant agent from the suppressant tanks 102.

In some embodiments, each of the suppressant tanks 102 stores a same inert gas or a same mixture of inert gases. In some embodiments, each of the suppressant tanks 102 include a correspondingly sized orifice 120 that can be configured to control the rate of discharge when the fire suppression system 100 can be activated.

Referring to FIG. 9, the low pressure side of the shuttle 622 of the activation unit 600 may include a pressure gauge or switch 640 fluidly coupled with the inner volume 608 through the first outlet 614, a burst disc 644 (e.g., a safety or safety over pressure burst disc) fluidly coupled with a pressure relief opening 642, and a valve 648 fluidly coupled with a pressurization opening 646. In some embodiments, the pressure gauge or switch 640 can be an electronic sensor that can be communicably coupled with a controller and can be configured to notify response personnel when the fire suppression system 100 activates (e.g., when the pressure on the low pressure side of the shuttle 622 lowers to a fault condition or significantly decreases and the shuttle 622 translates) and provides a reading for service personnel to identify if the low pressure side of the shuttle 622 can be properly pressurized. In some embodiments, the pressure gauge 640 displays pressure within the low pressure side of the shuttle 622 of the inner volume 608. In some embodiments, the pressure gauge 640 prompts servicing and line pressure validation when the pressure gauge 640 reads less than the normal (temperature corrected) pressure (e.g., 15 bar). In some embodiments, the pressure gauge 640 can be configured to trigger a fault alert or alarm when the pressure gauge 640 reads low (e.g., 9 or 10 bar). In some embodiments, the pressure gauge 640 can be configured to prompt notification of a fire or thermal event (and thereby activation of the fire suppression system 100) when the pressure gauge or switch 640 reads very low such as 4 bar or less.

Referring still to FIG. 9, the burst disc 644 can be fluidly coupled with the inner volume 608 (e.g., the low pressure side of the shuttle 622) via the pressure relief opening 642. In some embodiments, the burst disc 644 can be configured to rupture or relieve pressure from the inner volume 608 in response to the pressure within the inner volume 608 on the low pressure side exceeding a threshold amount (e.g., 30 bar) in order to ensure that the pressure within the inner volume 608, tubular members 104 or conduit 106 does not become excessively high. In some embodiments, the activation unit 600 can include a frangible seal, etc., to provide pressure relief of the low pressure side of the inner volume 608 of the activation unit 600.

Referring still to FIG. 9, the valve 648 may be a pneumatic or selective valve (e.g., a Schrader valve) that can be configured to allow pressurization of the inner volume 608 and initial system charging or recharging of tubular members 104, thermally responsive tubular members 106, tubular members 114, etc. For example, the valve 648 may be fluidly coupled with a tank 652 via a tubular member 650. In some embodiments, the valve 648 can be selectively fluidly coupled with the tank 652 via the tubular member 650. For example, a technician may be prompted, based on the reading of the pressure gauge 640, that the pressure within the inner volume 608 (and tubular members 104, thermally responsive tubular members 106, tubular members 114, etc.) on the low pressure side, that additional pressurization of the inner volume 608 on the low pressure side of the shuttle 622 should be provided. The technician may then couple the tubular member 650 onto the valve 648 such that the inner volume 608 can be pressurized with additional pressure from the tank 652. In some embodiments, the tank 652 can be a supplemental or supplementary container that can be pressurized at the pressure within the thermally responsive tubular member 106 such that the tank 652 keeps the pressure within the inner volume 608 on the low pressure side at a constant value, such as 15 bar, by providing an additional volume of inert gas to compensate for losses or temperature related pressure changes between service intervals.

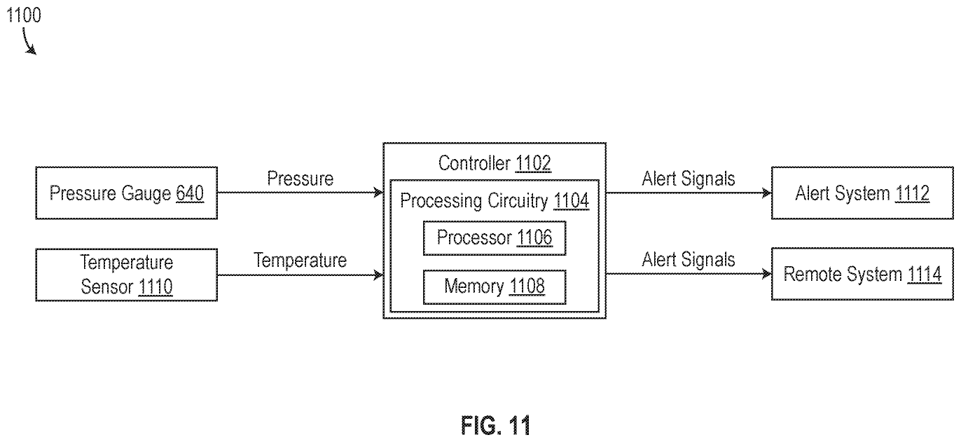

Referring to FIG. 11, a control system 1100 for the fire suppression system 100 can include a controller 1102, the pressure gauge 640 or a pressure sensor, a temperature sensor 1110, an alert system 1112, and a remote system 1114, according to some embodiments. In some embodiments, the controller 1102 can be configured to notify a technician or response crew when the controller 1102 detects that the fire suppression system 100 has activated or that a fire event or thermal event has occurred at an asset that the fire suppression system 100 protects. In some embodiments, the controller 1102 can be configured to obtain the pressure of the inner volume 608 on the low pressure side of the shuttle 622 from the pressure gauge 640 and, based on the pressure provided by the pressure gauge 640, compared to different pressure thresholds, identify if (a) the fire suppression system 100 has been activated, or (b) if the inner volume 608 on the low pressure side of the shuttle 622 has depressurized. In some embodiments, the controller 1102 can be also configured to obtain temperature feedback from the temperature sensor 1110 to determine if a fire event or thermal event has occurred. In some embodiments, the temperature sensor 1110 can be positioned at one or more assets (e.g., electrical components or protected components of the wind turbine 10) and can be configured to monitor temperature elevations of the one or more assets to identify if a thermal event has occurred at any of the assets that the fire suppression system 100 serves. In response to detecting that a thermal event or a fire event has occurred at any of the assets, components, zones, devices, etc., that the fire suppression system 100 serves, the controller 1102 can be configured to operate the alert system 1112 or the remote system 1114 in order to provide a notification to an operator, technician, service crew, response crew, fire department, etc., or automate power and plant shutdown, etc. While the fire suppression system 100 can be activated mechanically using any of the techniques described herein, the control system 1100 may operate in parallel in order to provide notification or prompt response for a crew. The alert system 1112 may be positioned locally at the wind turbine 10 or the system that the fire suppression system 100 serves. In some embodiments, the remote system 1114 can be positioned at a station (e.g., a fire station) or can be a personal computer device of a technician.

The controller 1102 may notify the response crew that a fire event or thermal event has occurred at one or more assets that the fire suppression system 100 serves, and also notify, based on an estimated discharge rate of the inert gas or the suppressant agent and a total capacity of the suppressant tanks 102, an amount of time that the response crew has to arrive at the wind turbine 10 before all of the suppressant agent or inert gas of the suppressant tanks 102 is discharged. In some embodiments, the controller 1102 can be configured to provide a notification to the response crew including the amount of time that the fire suppression system 100 can maintain discharge of the inert gas or the suppressant agent so that the response crew can be informed of elapsing time until the fire suppression system 100 can be no longer able to discharge the inert gas.

In some embodiments, the controller 1102 can be also configured to provide a notification to a technician or operator that the pressurization of the inner volume 608 of the activation unit 600 on the low pressure side of the shuttle 622 can be low. The technician may thereby be prompted to connect or couple the tank 652 to the valve 648 such that the low pressure side of the shuttle 622 can be brought up to a desired pressure.

Controller 1102 can be shown to include processing circuitry 1104 including a processor 1106 and memory 1108. Processor 1106 may be a general purpose or specific purpose processor, an application specific integrated circuit (ASIC), one or more field programmable gate arrays (FPGAs), a group of processing components, or other suitable processing components. Processor 1106 can be configured to execute computer code or instructions stored in memory 1108 or received from other computer readable media (e.g., CDROM, network storage, a remote server, etc.).

Memory 1108 may include one or more devices (e.g., memory units, memory devices, storage devices, etc.) for storing data and/or computer code for completing and/or facilitating the various processes described in the present disclosure. Memory 1108 may include random access memory (RAM), read-only memory (ROM), hard drive storage, temporary storage, non-volatile memory, flash memory, optical memory, or any other suitable memory for storing software objects and/or computer instructions. Memory 1108 may include database components, object code components, script components, or any other type of information structure for supporting the various activities and information structures described in the present disclosure. Memory 1108 may be communicably connected to processor 1106 via processing circuitry 1104 and may include computer code for executing (e.g., by processor 1106) one or more processes described herein. When processor 1106 executes instructions stored in memory 1108, processor 1106 generally configures controller 1102 (and more particularly processing circuitry 1104) to complete such activities.

In some embodiments, controller 1102 includes a communications interface (e.g., a USB port, a wireless transceiver, etc.) configured to receive and transmit data. The communications interface may include wired or wireless communications interfaces (e.g., jacks, antennas, transmitters, receivers, transceivers, wire terminals, etc.) for conducting data communications external systems or devices. In various embodiments, the communications may be direct (e.g., local wired or wireless communications) or via a communications network (e.g., a WAN, the Internet, a cellular network, etc.). For example, the communications interface can include a USB port or an Ethernet card and port for sending and receiving data via an Ethernet-based communications link or network. In another example, the communications interface can include a Wi-Fi transceiver for communicating via a wireless communications network or cellular or mobile phone communications transceivers. In some embodiments, the communications interface facilitates wired or wireless communications between controller 1102 and sensor(s), meter(s), the alert system 1112, and/or the remote system 1114.

### Alternative Implementations

Referring to FIGS. 1-11, the fire suppression system 100 can be provided for use with systems and components other than the wind turbine 10 as described in FIGS. 1-4. For example, the fire suppression system 100 can be used on oil rigs, hydrocarbon extraction systems, mining systems, vehicles, forestry equipment, farming or agricultural equipment, data centers, buildings, computer centers, aircrafts, robotics, factory and production line machinery and motor control center cabinets (MCCs), etc. In some embodiments, the fire suppression system 100 is advantageous for systems that are remote or removed from response crews since the fire suppression system 100 can easily be designed so that the fire suppression system 100 provides a desired time of suppression of the assets or components of the system by designing the size of the orifice of the orifice plate 630 and by installing addition suppressant tanks 102 to increase the hold time of the fire suppression.

Advantageously, the activation unit 600 provides a selective activation of the fire suppression system 100 in response to changing pressure differential which occurs when a fire or thermal event occurs at one or more of the assets. The fire suppression system 100 may both suppress a fire and maintain a low level of oxygen in order to prevent re-ignition of the fire or thermal event.

### Alternative Configurations

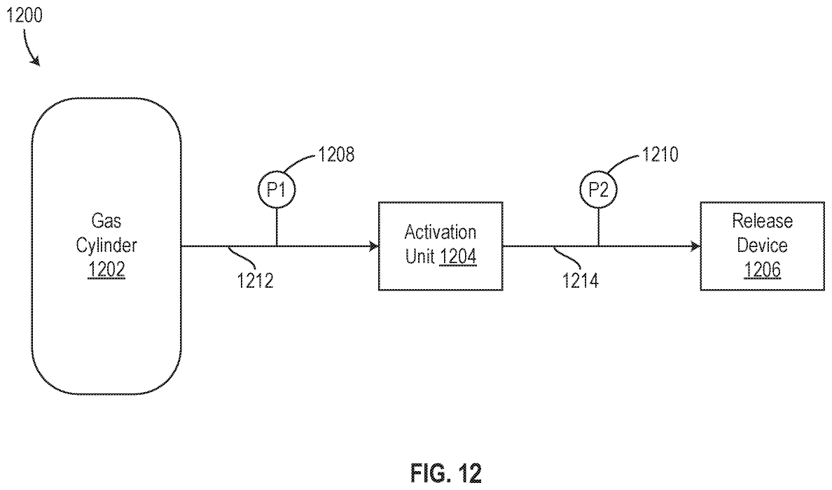

Referring to FIG. 12, a fire suppression system 1200 (e.g., the fire suppression system 100) can include one or more gas cylinders 1202 (e.g., the tanks 102), an activation unit 1204 (e.g., the activation unit 600), and a release device 1206 (e.g., the thermally responsive tubular members 106), according to some embodiments. In some embodiments, the gas cylinder 1202 can be configured to provide inert gas to the activation unit 1204 via tubular member or conduit 1212 at a first pressure P1, illustrated by pressure gauge 1208. In some embodiments, the pressure P1 of the conduit 1212 can be a high pressure side of the activation unit 1204. The activation unit 1204 can be fluidly coupled with the release device 1206 via one or more tubular members, shown as conduit 1214. In some embodiments, the activation unit 1204 exits or discharges to the release device 1206 on a lower-pressure side through the conduit 1214. In some embodiments, the lower-pressure side of the activation unit 1204 can be pressurized to a second pressure P2, illustrated by pressure gauge 1210 that can be lower than the first pressure P1.

Referring still to FIG. 12, the activation unit 1204 may be maintained in a deactivated state (e.g., a quiescent state, a non-fire state, etc.) with P1 being substantially greater than P2, when P2 can be greater than atmospheric pressure. The activation unit 1204 may divide, fluidly de-couple, or limit transmission of gas or fluid between the conduit 1212 and the conduit 1214. In some embodiments, the activation unit 1204 prevents flow of the inert gas from the conduit 1212 to the conduit 1214. In some embodiments, the release device 1206 seals the conduit 1214 on the low-pressure side of the activation unit 1204 to maintain the pressure P2 above atmospheric pressure. When the release device 1206 opens to atmospheric pressure, the low-pressure side of the activation unit 1204 can be vented to atmospheric pressure and the pressure differential across the activation unit 1204 changes.

Once the release device 1206 opens to atmospheric pressure, gas may be discharged from the low-pressure side of the activation unit 1204 such that the pressure P2 drops below a threshold pressure (e.g., the pressure P2 can be substantially equal to the atmospheric pressure) which causes the activation unit 1204 to transition into an open position or activated state (e.g., an open flow state, a fire condition state, etc.) and allow the inert gas or gaseous suppressant agent to flow through the activation unit 1204 and discharge onto a fire or protected asset via the release device 1206. When the activation unit 1204 is in the deactivated state, the shuttle 622 covers the third outlet 618 (e.g., and seals with the seals 610) such that flow of the fire suppression agent through the third outlet 618 is “limited.”

In some embodiments, the fire suppression system 1200 can include an orifice that can be positioned upstream or downstream of the release device 1206. The orifice can reduce pressure to within a desired pressure when the activation unit 1204 transitions into the activated state. In some embodiments, the orifice affects or determines a discharge rate (e.g., speed, volumetric flow rate, mass flow rate, etc.) of the release device 1206.

Referring still to FIG. 12, the release device 1206 may be a thermally responsive tubular member or other gas conduit (e.g., the thermally responsive tubular members 106 as described in greater detail above with reference to FIGS. 1-11). In some embodiments, the release device 1206 can be a soldered fitting or one or more soldered holes in a discharge or delivery device (e.g., a conduit, a tubular member, a pipe, a manifold, etc.) that are configured to melt and thereby release a fitting or expose holes of the discharge or delivery device (e.g., the release device 1206). In some embodiments, the release device 1206 can be provided as a channel in a battery or equipment enclosure including a portion of channel that melts to release the inert gas or suppressant agent into the enclosure in response to a thermal event within the battery or equipment enclosure.

Referring still to FIG. 12, the activation unit 1204 may include a shuttle (e.g., similar to the embodiments described in greater detail above with reference to FIGS. 5-8). In some embodiments, the activation unit 1204 can be or can include a check or a flapper valve that can be configured to transition between the deactivated state and the activated state once the pressure of the conduit 1214 can be released to atmosphere. In some embodiments, the activation unit 1204 can be or can include a burst disk that can rupture to allow the egress of the inert gas or suppressant agent through the activation unit 1204 in response to the conduit 1214 being vented to atmospheric pressure (e.g., in response to the release device 1206 transitioning into a released state).

Referring to FIGS. 8-9 and 12, the low-pressure side of the fire suppression system 600 or the fire suppression system 1200 can be serviced to recharge the pressure on the low-pressure side of the activation unit 1204 or the activation unit 600 (e.g., to maintain the pressure P2 at a desired level) by providing a port that a technician can attach a pump system to. In some embodiments, the low-pressure side can be pressurized by a pressurized reservoir that can be fluidly coupled with the low-pressure side of the activation unit 1204. In some embodiments, the low-pressure side can be pressurized by a compressor with an automatic pressure switch in order to control cycling of the compressor (e.g., an automatic air maintenance device compressor controller that automatically controls on-off cycling of an air compressor). In some embodiments, the low-pressure side of the activation unit 1204 can be recharged from the high-pressure side of the activation unit 1204. For example, the fire suppression system 1200 may include a bypass line that extends from the conduit 1212 to the conduit 1214 and can include a high pressure reducing valve, or a regulator, or a combination of an orifice, a solenoid valve, and an air maintenance device compressor control.

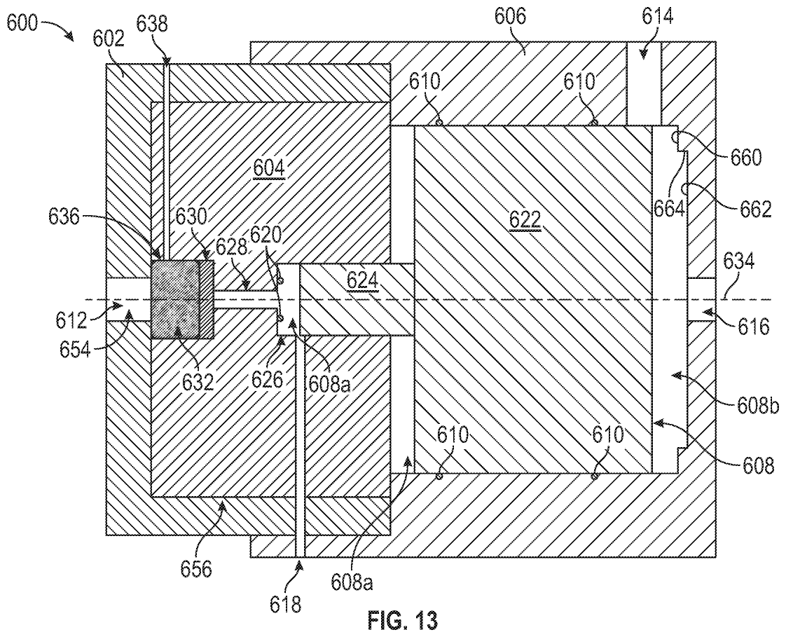

Referring to FIGS. 13-17, the activation unit 600 may include the third outlet 618 fluidly coupled with the first inner volume 608a instead of the second inner volume 608b. Fluidly coupling the third outlet 618 with the first inner volume 608a instead of the second inner volume 608b (e.g., on the smaller bore) facilitates reseating of the shuttle 622 if a leak occurs. The third body member 606 also can include a conical end, shown as shoulder 664 (e.g., a step) defined between first surfaces 660 and second surfaces 662. The first surfaces 660 and the second surfaces 662 may define a gap between an end of the shuttle 622 and the third body member 606 when the shuttle 622 can be transitioned into the open position.

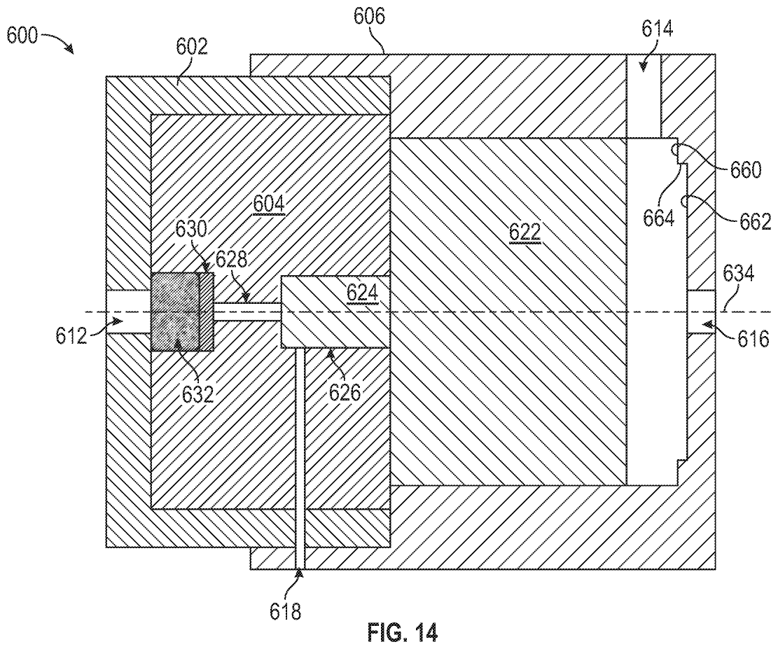

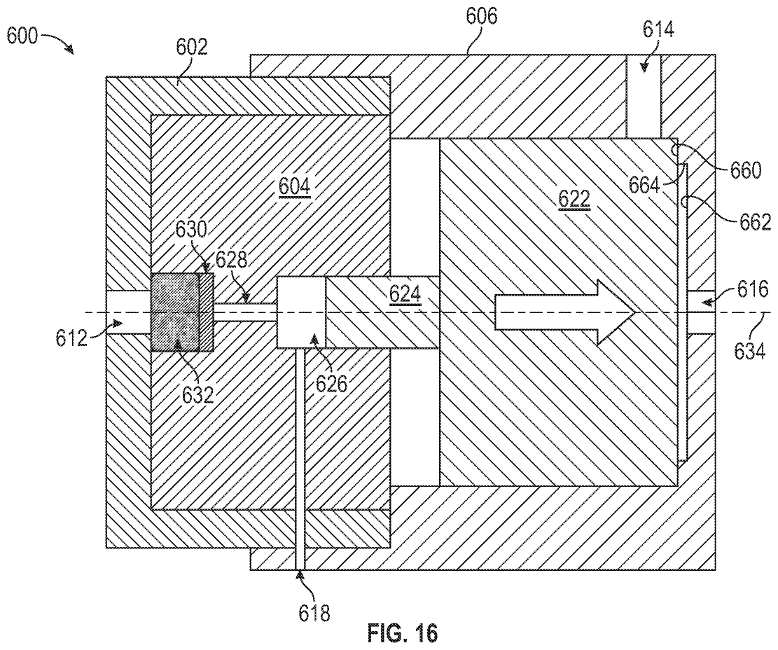

If a fire event occurs and the pressure on the shuttle 622 can be released, the shuttle 622 may transition from the closed position shown in FIG. 14 to the open position as shown in FIG. 16. When the shuttle 622 can be transitioned into the closed position as shown in FIG. 16, the fire suppression agent flows through the third outlet 618 through the first inner volume 608a.

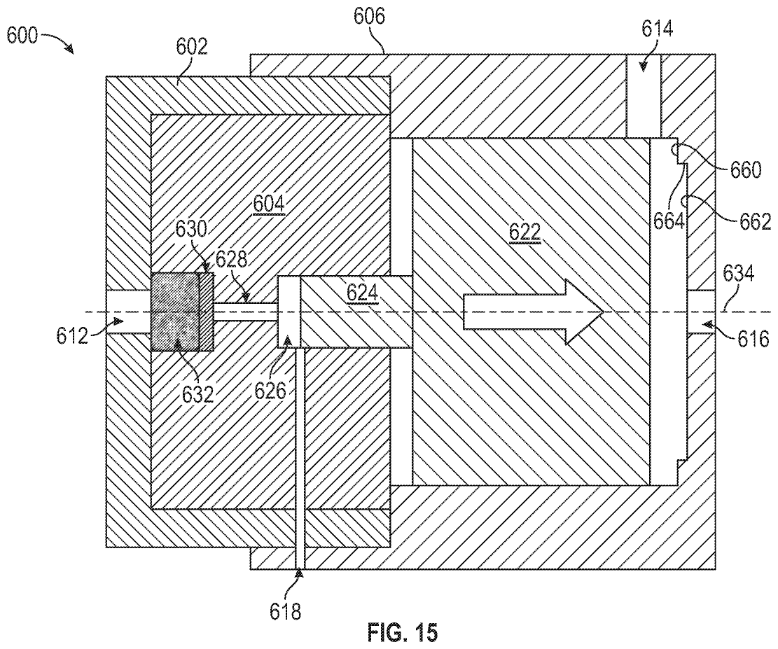

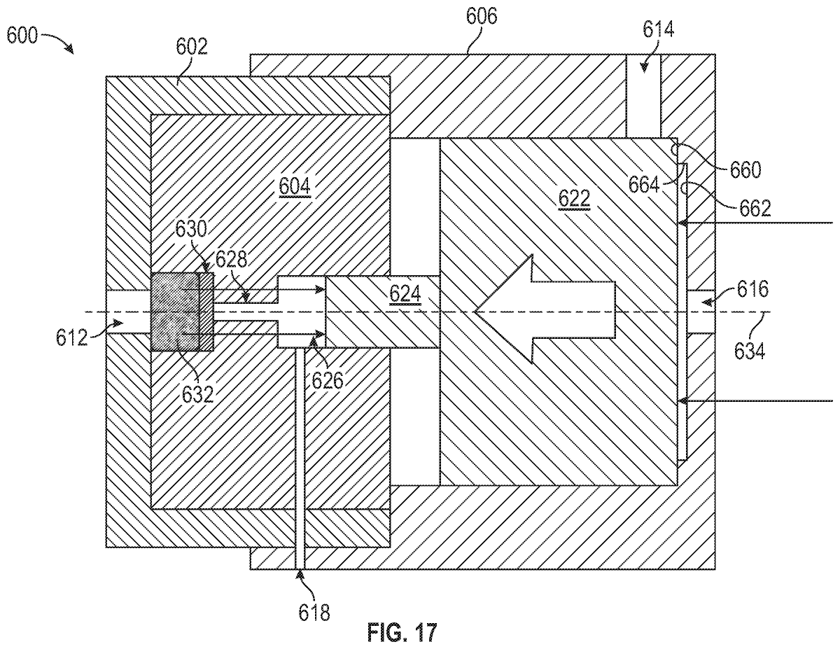

If a leak occurs such that the pressure on the shuttle 622 to hold the shuttle 622 in the closed position begins releasing, the shuttle 622 may transition partially into the open position as shown in FIG. 15 or the open position as shown in FIG. 16. The fire suppression agent may flow through the third outlet 618 and re-pressurize the thermally responsive tubular members 106. This can cause pressure to re-build downstream of the shuttle 622 to bias the shuttle 622 back into the closed position. As shown in FIG. 17, the pressure may build in the gap or chamber defined between the end of the shuttle 622 and the second surface 662 to re-seat the shuttle 622 in the closed position as shown in FIG. 14. Advantageously, fluidly coupling the third outlet 618 with the first inner volume 608a facilitates re-seating and re-pressurization of the shuttle 622 in the case of a leakage.

### Configuration of Exemplary Embodiments

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, and/or illustrations of possible embodiments (and such terms are not intended to connote that such embodiments are necessarily extraordinary or superlative examples).

The term “coupled,” as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. Such members may be coupled mechanically, electrically, and/or fluidly.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the fire suppression system as shown in the various exemplary embodiments is illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied.

Accordingly, all such modifications are intended to be included within the scope of the present disclosure. Other substitutions, modifications, changes, and omissions may be made in the design, operating conditions and arrangement of the exemplary embodiments without departing from the scope of the present disclosure.

What is claimed is:

1. A fire suppression system comprising:
a suppressant tank configured to store a gaseous fire suppressant agent;
an activation unit comprising an inlet and an outlet, the inlet fluidly coupled with the suppressant tank; and
a release device fluidly coupled with the outlet, the release device configured to maintain a pressure on a low pressure side in the activation unit, the pressure on the low pressure side configured to be released in response to a thermal event or device operation at an asset that the fire suppression system serves;
wherein the activation unit is configured to transition from a deactivated state in which the gaseous fire suppressant agent is limited from discharging through the activation unit, to an activated state in which the gaseous fire suppressant agent is discharged through the activation unit and the release device to provide fire suppression for the asset;
wherein the activation unit is configured to transition from the deactivated state to the activated state in response to the pressure on the low pressure side of the activation unit being released.

2. The fire suppression system of claim 1, wherein the activation unit comprises at least one of:
a shuttle positioned within a housing, the shuttle configured to move in response to release of the pressure on the low pressure side of the activation unit to transition the activation unit between the deactivated state and the activated state;
a check valve configured to transition the activation unit from the deactivated state to the activated state in response to release of the pressure on the low pressure side of the activation unit;
a flapper valve configured to transition the activation unit from the deactivated state to the activated state in response to release of the pressure on the low pressure side of the activation unit; or
a burst disk configured to transition the activation unit from the deactivated state to the activated state in response to release of the pressure on the low pressure side of the activation unit.

3. The fire suppression system of claim 1, wherein the release device comprises at least one of:
a thermally responsive tubular member or gas conduit configured to melt in response to the thermal event at the asset to release the pressure on the low pressure side of the activation unit;
a soldered fitting or soldered hole on a delivery device configured to melt in response to the thermal event at the asset to release the pressure on the low pressure side of the activation unit;
a channel in an enclosure of the asset configured to melt in response to the thermal event at the asset to release the pressure on the low pressure side of the activation unit; or a solenoid device in, or upstream of, an enclosure configured to be controlled and externally instructed to release the pressure on the low pressure side of the activation unit and allow flow through the solenoid device to the asset.

4. The fire suppression system of claim 1, wherein the low pressure side of the activation unit is configured to maintain the pressure on the low pressure side based on the release device not having released the pressure on the low pressure side.

5. The fire suppression system of claim 4, further comprising at least one of:
a connection point configured to receive a pump system to maintain the pressure on the low pressure side;
a pressurized reservoir configured to fluidly couple with the low pressure side of the activation unit to maintain the pressure on the low pressure side;
a compressor configured to fluidly couple with the low pressure side of the activation unit to maintain the pressure on the low pressure side, wherein cycling of the compressor is controlled by an automatic air maintenance controller; or
a bypass line extending from a high pressure side of the activation unit proximate the inlet of the activation unit to the low pressure side of the activation unit to maintain the pressure on the low pressure side.

6. The fire suppression system of claim 1, wherein:
the activation unit comprises a shuttle positioned within a housing, the shuttle configured to move in response to release of the pressure on the low pressure side of the activation unit to transition the activation unit between the deactivated state and the activated state; and
the release device comprises a thermally responsive tubular member or gas conduit configured to melt in response to the thermal event at the asset to release the pressure on the low pressure side of the activation unit;
wherein the shuttle, in the deactivated state, is configured to seal a discharge outlet to limit discharge of the fire suppression agent through the discharge outlet.

7. The fire suppression system of claim 6,
wherein the shuttle comprises a first surface area and a second surface area, the first surface area greater than the second surface area and configured to interface with a back-pressure from the release device, and the second surface area configured to interface with a pressure from the suppressant tank, wherein a force exerted on the shuttle by the back-pressure from the release device on the first surface area is greater than or equal to a force exerted on the shuttle by the suppressant tank;
wherein when the thermally responsive tubular member or the gas conduit is unruptured, the shuttle is maintained in a first position in which a flow path from the suppressant tank to the thermally responsive tubular member or the gas conduit is sealed such that the gaseous fire suppressant agent is limited from flowing through the discharge outlet by the shuttle closing the discharge outlet to the thermally responsive tubular member or the gas conduit;
wherein when the thermally responsive tubular member or the gas conduit is ruptured, the back-pressure on the shuttle is released and the shuttle is driven to move out of the first position and into a second position by the pressure from the suppressant tank, wherein when the shuttle is in the second position, the gaseous fire suppressant agent is allowed to flow through the discharge outlet to the thermally responsive tubular member or the gas conduit.

8. A fire suppression system comprising:
at least one suppressant tank configured to store a gaseous fire suppressant agent;
at least one tubular member in fluid communication with the at least one suppressant tank and extending proximate a component or area that the fire suppression system serves; and
an activation member comprising a housing and a shuttle positioned within an inner volume of the housing, wherein the at least one tubular member comprises a first section extending from the at least one suppressant tank to an inlet of the activation member, and a second section extending from an outlet of the activation member to proximate the component or area that the fire suppression system serves;
wherein the shuttle is movable between a closed position in which the outlet of the activation member is covered by the shuttle such that the fire suppression system does not provide the gaseous fire suppressant agent to the component or area that the fire suppression system serves, and an open position in which a fluid flow path between the outlet of the activation member and the inlet is defined through the inner volume such that the fire suppression system provides the gaseous fire suppressant agent to the component or area that the fire suppression system serves;
wherein the shuttle is movable between the closed position and the open position in response to a change in a pressure differential across the shuttle due to a fire event or thermal event occurring at the component or area that the fire suppression system serves.

9. The fire suppression system of claim 8, wherein the shuttle comprises a piston that seals with an inner cylindrical or conical surface of the activation member.

10. The fire suppression system of claim 8, wherein the activation member comprises a filter and an orifice plate positioned along the fluid flow path, wherein the fluid flow path is defined between the inlet of the activation member and the outlet of the activation member, the shuttle configured to block the fluid flow path when in the closed position and allow the fluid flow path through the inner volume of the activation member when in the open position.

11. The fire suppression system of claim 8, wherein the activation member comprises:
an opening that extends through a wall in the activation member in a longitudinal direction, the opening being fluidly coupled with a second tubular member that fluidly couples with the second section of the tubular members;
wherein the second section of the tubular members comprise at least one thermally responsive tubular member or solenoid valve positioned proximate the area or component that the fire suppression system serves, the at least one thermally responsive tubular member configured to melt and break in response to the fire event or the thermal event;
wherein the second tubular member and the second section of the tubular members form a sealed inner volume when the at least one thermally responsive tubular member are integral and have not melted and broken or the solenoid valve has operated, the second tubular member and the second section of the tubular members providing a back-pressure to the inner volume of the activation member that biases the shuttle into the closed position and holds the shuttle in the closed position;
wherein when the at least one thermally responsive tubular member melts and breaks, the back-pressure is released and the shuttle is driven by pressure of the gaseous fire suppressant agent at the inlet to move from the closed position to the open position such that the fluid flow path is defined between the inlet and the outlet of the activation member, and the gaseous fire suppressant agent is discharged through the second section of the tubular members and the at least one thermally responsive tubular member via a melt or burst point or solenoid operation to the component or the area that the fire suppression system serves.

12. The fire suppression system of claim 11, wherein the gaseous fire suppressant agent exerts a pressure on a high pressure side of the shuttle that is greater than a pressure exerted on a low pressure side of the shuttle provided via the at least one tubular member.

13. The fire suppression system of claim 8, wherein the gaseous fire suppressant agent comprises at least one inert gas.

14. The fire suppression system of claim 8, wherein the outlet is fluidly coupled with a thermally responsive tubular member that is fluidly coupled with a pressure port on the housing of the activation member, wherein the outlet is configured to allow re-pressurization of the thermally responsive tubular member to re-seat the shuttle into the closed position responsive to a leak in the thermally responsive tubular member that causes the shuttle to transition out of the closed position.

15. An activation unit for a fire suppression system, the activation unit comprising:
a body defining an inner volume, the body configured to couple with a fire suppression agent source at an inlet, an outlet conduit at an outlet, and further including a pressure port; and
a shuttle disposed within the inner volume, the shuttle translatable between a first position and a second position, wherein in the first position the outlet is sealed shut and in the second position, the outlet is fluidly coupled with the fire suppression agent source through the inlet and the inner volume;
wherein the shuttle is configured to transition out of the first position and into the second position responsive to a decrease in pressure at the pressure port, the pressure port fluidly coupled with a chamber defined by the shuttle and the inner volume.

16. The activation unit of claim 15, wherein the pressure port and the outlet are both fluidly coupled with a thermally responsive tubular member, wherein rupturing of the thermally responsive tubular member causes the pressure at the pressure port to decrease such that a force exerted on an opposite side of the shuttle drives the shuttle to transition out of the first position and into the second position.

17. The activation unit of claim 15, wherein the shuttle comprises a first portion and a second portion, the first portion having a first diameter and the second portion having a second diameter, wherein the first diameter is greater than the second diameter.

18. The activation unit of claim 15, wherein the activation unit comprises a passageway that fluidly couples the inlet with the fire suppression agent source, wherein an orifice restrictor is disposed along the passageway.

19. The activation unit of claim 15,
wherein the shuttle defines a first chamber and a second chamber within the inner volume, the first chamber having a first pressure and the second chamber having a second pressure less than the first pressure, wherein the second chamber fluidly couples with the pressure port and the first chamber fluidly couples with the inlet; and
wherein the shuttle comprises a first surface area on which the first pressure acts, and a second surface area on which the second pressure acts, wherein the first surface area is smaller than the second surface area.

20. The activation unit of claim 15, wherein the activation unit comprises a passageway that fluidly couples the inlet with the fire suppression agent source, wherein an orifice restrictor plate and a filter are disposed along the passageway.
